(19) United States
(12) Patent Application Publication
(10) Pub. No.: US 2013/0112539 A1
(43) Pub. Date: May 9, 2013

(54) Removable Circuit Interrupter that Provides Circuit-Testing Capabilities

(71) Applicants: Christopher M. Cacioppo, Somerville, MA (US); David J. Dean, Cambridge, MA (US); Hector Padilla, Chelsea, MA (US); Timothy Higgins, Allston, MA (US); Daryl Vankampen, Cambridge, MA (US)

(72) Inventors: Christopher M. Cacioppo, Somerville, MA (US); David J. Dean, Cambridge, MA (US); Hector Padilla, Chelsea, MA (US); Timothy Higgins, Allston, MA (US); Daryl Vankampen, Cambridge, MA (US)

(73) Assignee: Sanford L.P., Oak Brook, IL (US)

(21) Appl. No.: 13/703,099

(22) PCT Filed: Jul. 18, 2011
(86) PCT No.: PCT/US11/44398

§ 371 Date: Jan. 16, 2013

Related U.S. Application Data
(60) Provisional application No. 61/365,192, filed on Jul. 16, 2010.

(51) Int. Cl. H01H 9/00

(52) U.S. Cl. CPC H01H 9/00
USPC 200/506; 324/511

(57) ABSTRACT

A removable circuit interrupter with circuit-testing capabilities. In one embodiment, a removable circuit interrupter is provided for use with a battery-powered device. The battery-powered device includes a battery and a load that is electrically coupled to the battery. The removable circuit interrupter is configured to be disposed between the battery and the load. The removable circuit interrupter includes a first outer surface having a conductive layer. The removable circuit interrupter further includes a second outer surface having an non-conductive layer. The conductive layer is configured to electrically couple to one of the battery and the load. The non-conductive layer is configured to electrically couple to another one of the battery and the load.

### FIELD OF DISCLOSURE

The present disclosure relates generally to circuit interrupters and, more particularly, to removable circuit interrupters that provide testing capabilities.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure

For convenience of purchasers, battery-operated devices are desirably shipped from the manufacturer with batteries pre-installed. However, if the batteries are connected to the devices while shipped, there exists the likelihood of constant drain on the battery. For products having long distances to travel from manufacturer to customer, and/or long storage or shelf-life prior to purchase, the constant current draw on the battery will slowly drain the battery, resulting in the device being delivered to the customer with the batteries significantly, or in extreme cases, entirely discharged prior to use.

Consumers find it frustrating when they have to replace or charge batteries upon or soon after removing a new device from its packaging. Additionally, draining the battery can detrimentally affect future performance of some devices, and can damage the battery, the device, or both.

In some countries, regulatory requirements dictate that battery-operated devices imported or otherwise transported or stored have their batteries disconnected during shipment or storage. One solution to these problems has been to sell battery-operated devices separately from batteries. Other solutions have been, instead of pre-installing batteries, including a package of batteries, shrink-wrapped batteries, or battery-retaining portions of plastic or Styrofoam packaging within the packaging for the battery-powered device. However, even where batteries are supplied in the same packaging, battery installation may be difficult, and on many devices require the use of tools, such as screwdrivers (often with small Phillips-style or flat heads) to remove small screws in order to access the battery compartment.

A more recent technique to avoid battery drainage has been the employment of removable pull-tabs as temporary interrupters interposed somewhere within the circuit that the battery is intended to power. In some instances, this takes the form of interrupters comprising two contacts that are spring loaded to maintain constant contact and enable a current to flow through the circuit. A small piece or slip of non-conductive material (e.g., Mylar) is placed between the contacts to prevent them from connecting. The user may then pull the slip of non-conductive material out of its position between the contacts, thereby completing the electrical circuit and enabling operation of the device.

A drawback shared by each of these alternative solutions is the inability to test the product prior to shipment, or the need to remove batteries or insert the non-conductive material slip subsequent to such testing. Moreover, a consumer cannot test a product while it is still in the packaging.

### SUMMARY

The present disclosure provides a removable circuit interrupter with circuit-testing capabilities.

In one embodiment, a removable circuit interrupter is provided for use with a battery-powered device. The battery-powered device includes a battery and a load that is electrically coupled to the battery. The removable circuit interrupter is configured to be disposed between the battery and the load. The removable circuit interrupter includes a first outer surface having a conductive layer. The removable circuit interrupter further includes a second outer surface having a non-conductive layer. The conductive layer is configured to electrically couple to one of the battery and the load. The non-conductive layer is configured to electrically couple to another one of the battery and the load.

In another embodiment, an apparatus includes a voltage source, a load that is electrically coupled to the voltage source, and a removable circuit interrupter that is disposed between the voltage source and the load. The removable circuit interrupter is configured to be disposed between the voltage source and the load. The removable circuit interrupter includes a first outer surface having a conductive layer. The removable circuit interrupter further includes a second outer surface having an non-conductive layer. The conductive layer is configured to electrically couple to one of the voltage source and the load. The non-conductive layer is configured to electrically couple to another one of the voltage source and the load.

In another embodiment, an apparatus includes a voltage source, a load that is electrically coupled to the voltage source, and a removable circuit interrupter that is disposed between the voltage source and the load. The removable circuit interrupter is configured to be disposed between the voltage source and the load. The removable circuit interrupter includes a first outer surface having a conductive layer. The removable circuit interrupter further includes a second outer surface having an non-conductive layer. A current flows between the voltage source and the load when the conductive layer is electrically coupled to the voltage source and the load. However, no current flows between the voltage source and the load when the conductive layer is electrically coupled only to the voltage source or only to the load.

### BRIEF DESCRIPTION OF THE DRAWINGS

FIG. 1A schematically illustrates a battery-operated device with a removable circuit interrupter disposed between a battery and a load, where the circuit removable circuit interrupter has a non-conductive layer coupled to the negative terminal of the battery and a conductive layer coupled to the load;

FIG. 1B schematically illustrates the battery-operated device of FIG. 1A with the removable circuit interrupter removed;

FIG. 1C schematically illustrates the battery-operated device of FIG. 1A where the removable circuit interrupter is used to test the battery-operated device;

FIG. 2A schematically illustrates a battery-operated device with a removable circuit interrupter disposed between a battery and a load, where the circuit removable circuit interrupter has a non-conductive layer coupled to the load and a conductive layer coupled to the negative terminal of the battery;

FIG. 2B schematically illustrates the battery-operated device of FIG. 2A with the removable circuit interrupter removed;

FIG. 2C schematically illustrates the battery-operated device of FIG. 2A where the removable circuit interrupter is used to test the battery-operated device;

FIG. 3A schematically illustrates a battery-operated device with a removable circuit interrupter disposed between a battery and a load, where the circuit removable circuit interrupter has a non-conductive layer coupled to the load and a conductive layer coupled to the positive terminal of the battery;

FIG. 3B schematically illustrates the battery-operated device of FIG. 3A with the removable circuit interrupter removed;

FIG. 3C schematically illustrates the battery-operated device of FIG. 3A where the removable circuit interrupter is used to test the battery-operated device;

FIG. 4A schematically illustrates a battery-operated device with a removable circuit interrupter disposed between a battery and a load, where the circuit removable circuit interrupter has a non-conductive layer coupled to the positive terminal of the battery and a conductive layer coupled to the load;

FIG. 4B schematically illustrates the battery-operated device of FIG. 4A with the removable circuit interrupter removed;

FIG. 4C schematically illustrates the battery-operated device of FIG. 4A where the removable circuit interrupter is used to test the battery-operated device; and

FIG. 5 illustrates a perspective view of an example enclosure that may be used to house a battery-operated devices with a removable circuit interrupter.

Like reference numbers and designations in the various drawings indicate like elements.

### DETAILED DESCRIPTION

Although the following text sets forth a detailed description of numerous different embodiments of a removable circuit interrupter that provides circuit-testing capabilities, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim teen by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

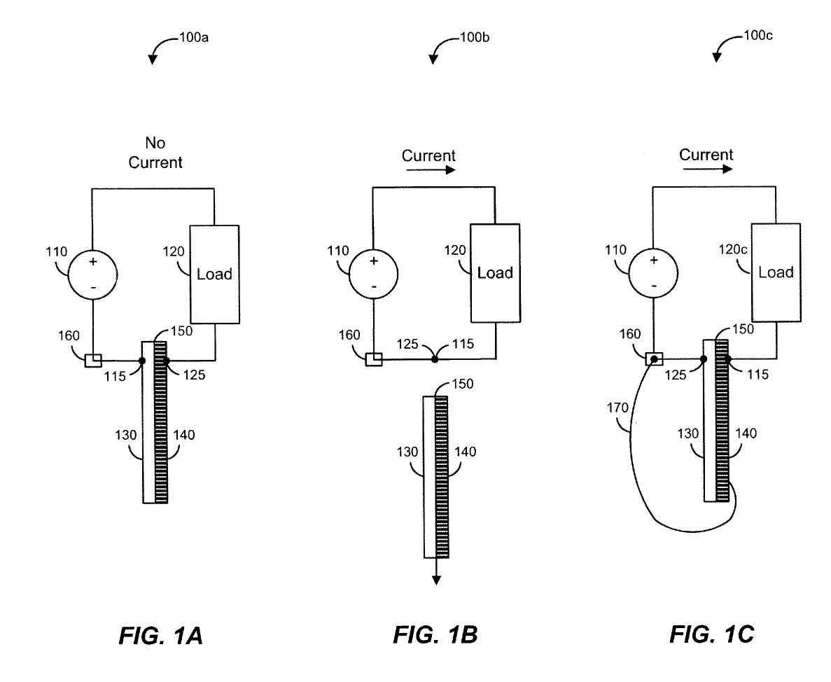

FIGS. 1A-1C illustrate an example battery-operated device 100 with a removable circuit interrupter 150. The battery-operated device 100 includes a battery 110 (or, more generally, a voltage source, or a current source) and a load 120 that is electrically coupled to the battery 110. Generally, the load 120 is a circuit, or a portion of a circuit that is powered at least partially by the battery 110. The battery-operated device 100a further includes two contacts 115, 125 that are spring loaded to maintain constant contact and to enable current to flow through the circuit between the battery 110 and the load 120 under normal operations, as illustrated in FIG. 1B. By use of the term “spring loaded,” it is to be understood that the two contacts 115, 125 are biased toward a position in which they maintain constant contact to enable current to flow through the circuit between the battery 110 and the load 120.

As illustrated in FIG. 1A, the removable circuit interrupter 150 may be disposed between the contacts 115, 125 to prevent them from connecting, and to prevent current from flowing between the battery 110 and the load 120. In the embodiment illustrated in FIGS. 1A-1C, the removable circuit interrupter 150 has one outer surface that includes a conductive layer 140 and one outer surface 130 that includes a non-conductive layer. The conductive layer 140 is configured to electrically couple to the load, and the non-conductive layer 130 is configured to electrically couple to the negative terminal of the battery 110. The conductive layer 140 may be provided on the whole outer surface or it may be provided on only a portion of the outer surface.

As illustrated in FIG. 1B, the user may pull the removable circuit interrupter 150 out of its position between the contacts 115, 125, thereby completing the electrical circuit, causing current to flow between the battery 110 and the load 120, and enabling normal operation of the battery-operated device 100. Additionally, as illustrated in FIG. 1, it is possible to test the battery-operated device 100 before (and without) pulling the removable circuit interrupter 150 out of its position between the contacts 115, 125 by electrically coupling the conductive layer 140 to the negative terminal of the battery 110 (e.g., using a wire 170) via a conductive testing contact 160, for instance, and causing current to flow between the battery 110 and the load 120. In one embodiment, the conductive testing contact 160 is positioned such that a flexible battery interrupter can be bended to bring the conductive layer 140 in contact with the conductive testing contact 160.

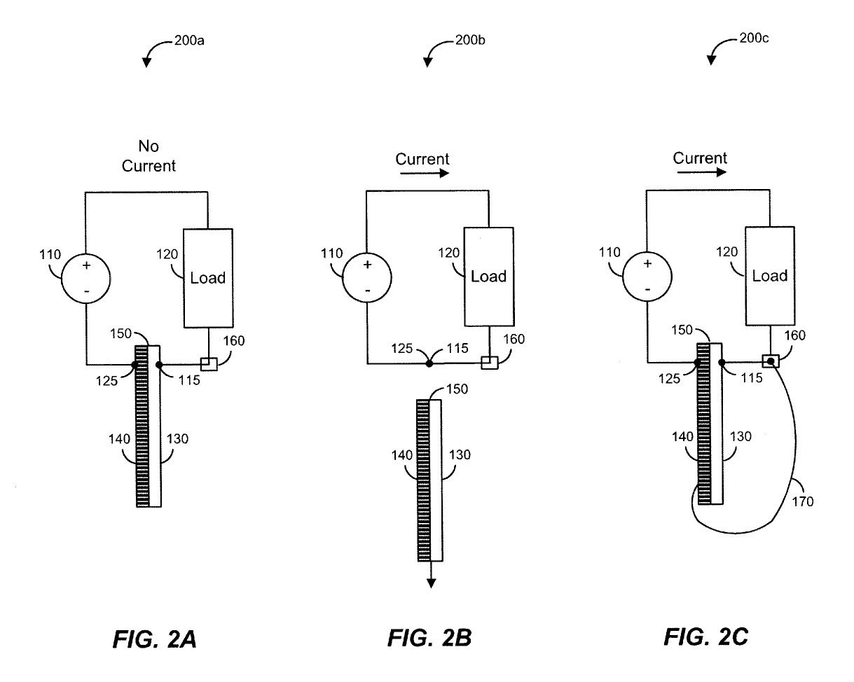

FIGS. 2A-2C illustrate another example battery-operated device 200 with a removable circuit interrupter 150. Similar to the embodiment illustrated in FIGS. 1A-1C, in the embodiment illustrated in FIGS. 2A-2C, the removable circuit interrupter 150 has one outer surface that includes a conductive layer 140 and one outer surface 130 that includes a non-conductive layer. The conductive layer 140 is configured to electrically couple to the negative terminal of the battery 110, and the non-conductive layer 130 is configured to electrically couple to the load 120. In this embodiment, it is possible to test the battery-operated device 200 before pulling the removable circuit interrupter 150 out of its position between the contacts 115, 125 by electrically coupling the conductive layer 140 to the load 120 (e.g., using a wire 170) via a conductive testing contact 160, for instance, and causing current to flow between the battery 10 and the load 120.

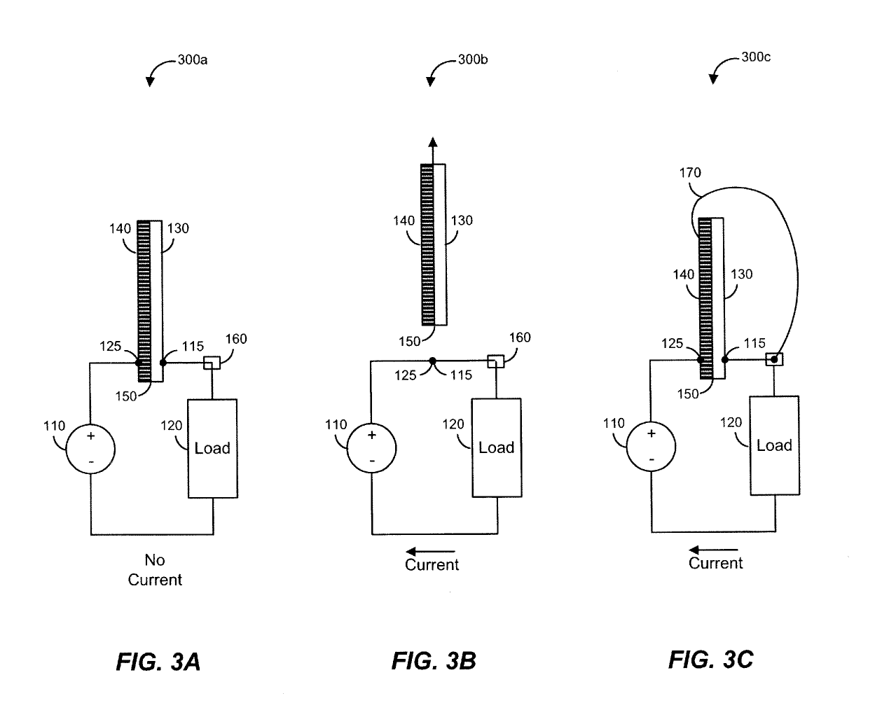

FIGS. 3A-3C illustrate another example battery-operated device 300 with a removable circuit interrupter 150. Similar to the embodiment illustrated in FIGS. 1A-1C, in the embodiment illustrated in FIGS. 3A-3C, the removable circuit interrupter 150 has one outer surface that includes a conductive layer 140 and one outer surface 130 that includes a non-conductive layer. The conductive layer 140 is configured to electrically couple to the positive terminal of the battery 110, and the non-conductive layer 130 is configured to electrically couple to the load 120. In this embodiment, it is possible to test the battery-operated device 300 before pulling the removable circuit interrupter 150 out of its position between the contacts 115, 125 by electrically coupling the conductive layer 140 to the load 120 (e.g., using a wire 170) via a conductive testing contact 160, for instance, and causing current to flow between the battery 110 and the load 120.

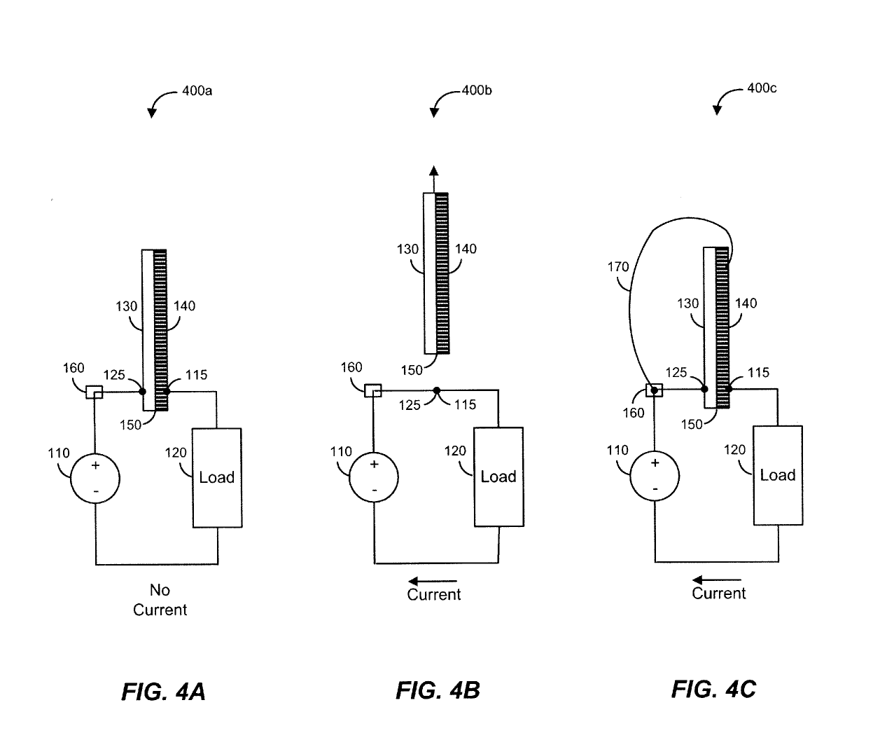

FIGS. 4A-4C illustrate another example battery-operated device 400 with a removable circuit interrupter 150. Similar to the embodiment illustrated in FIGS. 1A-1C, in the embodiment illustrated in FIGS. 4A-4C, the removable circuit interrupter 150 has one outer surface that includes a conductive layer 140 and one outer surface 130 that includes a non-conductive layer. The conductive layer 140 is configured to electrically couple to the load, and the non-conductive layer 130 is configured to electrically couple to the positive terminal of the battery 110. In this embodiment, it is possible to test the battery-operated device 400 before pulling the removable circuit interrupter 150 out of its position between the contacts 115, 125 by electrically coupling the conductive layer 140 to the positive tee urinal of the battery 110 (e.g., using a wire 170) via a conductive testing contact 160, for instance, and causing current to flow between the battery 110 and the load 120.

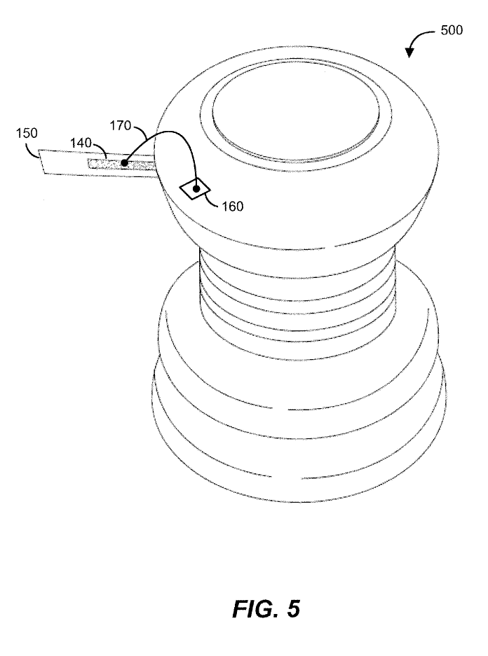

FIG. 5 illustrates a perspective view of an example enclosure 500 that may be used to house the one or more of the example battery-operated devices 100-400 with a removable circuit interrupter 150 of FIGS. 1-4. For more convenient testing, the testing contact 160 may be exposed on the surface of the enclosure. As a result, in order to test the battery-operated device in the enclosure 500 before pulling the removable circuit interrupter 150 out of its position, the conductive layer 140 of the removable circuit interrupter 150 may be electrically coupled (e.g., using a wire 170) to the conductive testing contact 160 on the surface.

While various embodiments have been described herein, it is to be understood that variations may be made to the embodiments as described that are still within the scope of the appended claims.

1-10. (canceled)

11. A removable circuit interrupter for use with a battery-powered device, the battery-powered device including a battery and a load electrically coupled to the battery, the removable circuit interrupter configured to be disposed between the battery and the load and comprising:
a first outer surface including a conductive layer; and
a second outer surface including [[an]] a non-conductive layer, wherein the conductive layer is configured to electrically couple to one of the battery and the load, and wherein the non-conductive layer is configured to couple to another one of the battery and the load.

12. The removable circuit interrupter of claim 11, wherein a current flows between the battery and the load when the conductive layer is electrically coupled to the another one of the battery and the load, and wherein no current flows between the battery and the load when the conductive layer is not electrically coupled to the another one of the battery and the load.

13. The removable circuit interrupter of claim 11, wherein the conductive layer is configured to electrically couple to the load, and wherein the non-conductive layer is coupled to the battery.

14. The removable circuit interrupter of claim 11, wherein the conductive layer is configured to electrically couple to the battery, and wherein the non-conductive layer is configured to couple to the load.

15. The removable circuit interrupter of claim 11, wherein the battery comprises a positive terminal and a negative terminal, and wherein the conductive layer is electrically coupled to the positive terminal.

16. The removable circuit interrupter of claim 11, wherein the battery comprises a positive terminal and a negative terminal, and wherein the conductive layer is configured to electrically couple to the negative terminal.

17. (canceled)

18. The removable circuit interrupter of claim 11, wherein the battery comprises a positive terminal and a negative terminal, and wherein the non-conductive layer is configured to couple to the positive terminal.

19. The removable circuit interrupter of claim 11, wherein the battery comprises a positive terminal and a negative terminal, and wherein the non-conductive layer is configured to couple to the negative terminal.

20-21. (canceled)

22. An apparatus for selectively interrupting an electrical circuit, the electrical circuit comprising a power source and a load, the power source electrically coupled to a first side of the load and to a first terminal, a second side of the load electrically coupled to a second terminal, the electrical circuit configured such that the first and second terminals are electrically coupled in the absence of the apparatus, the apparatus comprising:
a piece of generally planar, electrically-insulating material having a first surface and a second surface and configured to electrically decouple the first and second terminals when in place; and
an electrically conductive coating applied to at least a portion of the first surface and configured to electrically couple to either the first terminal or the second terminal when in place.

23. The apparatus of claim 22, wherein the electrically conductive coating is further applied to at least a portion of the second surface such that the coated portion of the second surface electrically couples the apparatus to the other of the first and second terminals.

24. The apparatus of claim 23, wherein the coated portion of the first surface and the coated portion of the second surface are electrically isolated from one another.

25. The apparatus of claim 22, wherein the coated portion of the first surface extends to the second surface.

26. The apparatus of claim 23, wherein the apparatus is configured such that the coated portions of the first and second surfaces, when brought into contact with one another, electrically couple the first terminal to the second terminal.

27. The apparatus of claim 22, wherein the coated portions of the first and second surfaces are configured such that flexure of the apparatus electrically couples the first terminal to the second terminal.

28. The apparatus of claim 22, wherein the first and second surfaces are configured such that flexure of the apparatus is inoperable to bring the first and second surfaces into contact with one another.

29. A method of configuring an apparatus for testing, the method comprising:
providing first and second electrical terminals;
electrically coupling the first electrical terminal to a power source of the apparatus;
electrically coupling the second electrical terminal to a load of the apparatus;
providing a deformable mechanical connection configured to electrically couple the first and second electrical terminals such that the power source operates to deliver power to the load;
positioning a removable circuit interrupt device to electrically isolate the first and second electrical terminals, the removable circuit interrupt device comprising a first surface and a second surface, one of the first and second surfaces electrically coupled to one of the first and second electrical terminals; temporarily forming a removable electrical connection between the one of the first and second surfaces and the other of the first and second terminals, thereby electrically coupling the first and second terminals;
performing a test on the apparatus while the removable connection is in place; and
removing the removable connection.

30. The method of claim 29, further comprising coating at least a portion of the one of the first and second surfaces with an electrically conductive material, wherein the removable circuit interrupt device is formed of an electrically insulating material.

31. The method of claim 29, further comprising coating at least a portion of the one of the first and second surfaces with an electrically insulating material, wherein the removable circuit interrupt device is formed of an electrically conducting material.

32. The method of claim 29, further comprising:
providing a test point on the apparatus; and
connecting the test point to the other of the first and second terminals; and
wherein forming a removable electrical connection between the one of the first and second surfaces and the other of the first and second terminals comprises forming a removable electrical connection between the one of the first and second surfaces and the test point.

33. The method of claim 29, further comprising:
coating the other of the first and second surfaces with the electrically conductive material; and wherein forming a removable electrical connection between the one of the first and second surfaces and the other of the first and second terminals comprises forming a removable electrical connection between the first and second surfaces of the removable circuit interrupt device.

34-53. (canceled)
